(19) United States
(12) Patent Application Publication
(10) Pub. No.: US 2026/0239129 A1
(43) Pub. Date: Aug. 13, 2026

(54) HANDOVER METHOD OF TERMINAL, TERMINAL, NETWORK SIDE DEVICE, NETWORK DEVICE, AND SYSTEM

(71) Applicants: CHINA TELECOM CORPORATION LIMITED TECHNOLOGY INNOVATION CENTER, Beijing (CN); CHINA TELECOM CORPORATION LIMITED, Beijing (CN)

(72) Inventors: Jiaxiang LIU, Beijing (CN); Zheng JIANG, Beijing (CN)

(21) Appl. No.: 19/638,875

(22) Filed: Apr. 3, 2026

Related U.S. Application Data
(63) Continuation of application No. PCT/CN2024/110658, filed on Aug. 8, 2024.

(30) Foreign Application Priority Data
Oct. 8, 2023 (CN) 202311291950.X

(51) Int. Cl. H04W 36/00; H04W 72/044

(52) U.S. Cl. CPC H04W 36/00725; H04W 36/0085; H04W 72/044

(57) ABSTRACT

The present disclosure provides a handover method of a terminal, a terminal, a network-side device, a network device and a system, which relates to the technical field of wireless communication. The handover method of the terminal of the present disclosure includes: the terminal receiving a RACH-less (Random Access Channel-less) handover instruction, wherein the RACH-less handover instruction comprises TA (Time Advance) compensation assistance information; the terminal initiating handover in the NTN based on the TA compensation assistance information.

### CROSS-REFERENCE TO RELATED APPLICATIONS

The present disclosure is based on and claims priority of Chinese application for invention 202311291950.X, filed on Oct. 8, 2023, the disclosure of which is hereby incorporated into this disclosure by reference in its entirety.

### TECHNICAL FIELD

This disclosure relates to the technical field of wireless communication, particularly to a handover method of a terminal, a terminal, a network-side device, a network device, and a system.

### BACKGROUND

With the freezing of 3GPP Release 17 (R17), Non-Terrestrial Networks (NTN) have introduced satellite nodes into mobile communication networks, enabling terminals to access networks via satellites and significantly expanding network coverage.

The communication delay of satellite nodes is significantly greater than that of terrestrial cellular networks, and excessive delay can easily lead to handover failures.

### SUMMARY

One objective of this disclosure is to propose a handover scheme for terminals in an NTN, to improve the success rate of handover.

According to one aspect of some embodiments of this disclosure, there is provided a handover method of a terminal, including: the terminal located in an NIN (Non-Terrestrial Network) receiving a RACH-less (Random Access Channel-less) handover instruction, wherein the RACH-less handover instruction includes TA (Time Advance) compensation assistance information; the terminal determining a TA compensation value based on the TA compensation assistance information; and the terminal sending initial access information to the NIN based on the TA compensation value.

In some embodiments, the TA compensation assistance information includes ephemeris information.

In some embodiments, the TA compensation assistance information further includes feeder link TA compensation information.

In some embodiments, the RACH-less handover instruction further includes pre-allocated time-frequency resource configuration information, the terminal handover method further includes: the terminal storing the time-frequency resource configuration information.

In some embodiments, the method further includes: the terminal obtaining pre-allocated time-frequency resource configuration information based on RRC (Radio Resource Control) information and storing the pre-allocated time-frequency resource configuration information.

In some embodiments, the terminal sending the initial access information to the NIN based on the TA compensation value includes: the terminal sending, in response to determining the TA compensation value, the initial access information to the NTN based on the TA compensation value according to the stored time-frequency resource configuration information.

In some embodiments, the method further includes: the terminal receiving dynamic authorization information from a target cell based on DCI (downlink control information); wherein the terminal sending the initial access information to the NIN based on the TA compensation value includes: the terminal sending, in response to receiving the dynamic authorization information, the initial access information to the NTN based on the TA compensation value, according to the dynamic authorization information.

In some embodiments, the terminal determining the TA compensation value based on the TA compensation assistance information includes: determining a feeder circuit TA compensation value based on the feeder link TA compensation information; determining a UE-specific TA compensation value based on the ephemeris information; and determining the TA compensation value based on the feeder circuit TA compensation value and the UE-specific TA compensation value.

In some embodiments, the terminal determining the TA compensation value based on the TA compensation assistance information further includes: the terminal determining a TA compensation measurement value; determining the TA compensation value based on the feeder circuit TA compensation value and the UE-specific TA compensation value includes: determining the TA compensation value based on the feeder circuit TA compensation value, the UE-specific TA compensation value, and in combination with the TA compensation measurement value, a TA offset, and a unit time duration.

In some embodiments, the determining the TA compensation measurement value includes: determining the TA compensation measurement value of a target cell to be identical to the TA compensation measurement value of a source cell, in a case where the source cell and the target cell correspond to the same satellite.

In some embodiments, the determining the TA compensation measurement value includes: determining the TA compensation measurement value to be a preset value, in a case where the source cell and the target cell correspond to different satellites.

In some embodiments, the method further includes: the terminal receiving access confirmation information, and determining an access being successful according to the access confirmation information.

In some embodiments, the access confirmation information is carried by a MAC (Medium Access Control) CE (Control Element).

In some embodiments, the method further includes: the terminal obtaining downlink data via a C-RNTI (Cell-Radio Network Temporary Identifier) scrambled PDCCH or PDSCH (Physical Uplink Shared Channel), wherein the terminal determines the access being successful according to the downlink data.

According to an aspect of some embodiments of this disclosure, there is provided a handover method of a terminal, including: a network-side device of an NTN sending handover preparation information to a target cell for the terminal handover; and the network-side device sending a RACH-less handover instruction, wherein the RACH-less handover instruction includes TA compensation assistance information.

In some embodiments, the RACH-less handover instruction further includes pre-allocated time-frequency resource configuration information for the terminal.

In some embodiments, the method further includes: sending the pre-allocated time-frequency resource configuration information to the terminal using RRC information.

In some embodiments, the method further includes: receiving dynamic authorization information from the target cell; and sending the dynamic authorization information to the terminal using DCI.

According to one aspect of some embodiments of this disclosure, there is provided a handover method of a terminal, including: a network-side device of an NTN obtaining handover preparation information from a source cell for the terminal handover; the network-side device obtaining initial access information from the terminal; and sending downlink data via a C-RNTI scrambled PDCCH or PDSCH.

In some embodiments, the method further includes: sending access confirmation information to the terminal.

In some embodiments, the access confirmation information is carried by a MAC CE.

In some embodiments, the method further includes: the network-side device generating dynamic authorization information for the terminal after receiving the handover preparation information; and sending the dynamic authorization information to the source cell.

According to one aspect of some embodiments of this disclosure, there is provided a terminal, including: an information acquisition unit configured to receive a RACH-less handover instruction from an NIN source cell, the RACH-less handover including compensation assistance instruction TA information; a compensation value determination unit configured to determine a TA compensation value based on the TA compensation assistance information; and an access unit configured to send initial access information to an NIN target cell based on the TA compensation value.

In some embodiments, the TA compensation assistance information includes ephemeris information and feeder link TA compensation information.

In some embodiments, the RACH-less handover instruction further includes pre-allocated time-frequency resource configuration information; the information acquisition unit is further configured to store the time-frequency resource configuration information.

In some embodiments, the information acquisition unit is further configured to obtain pre-allocated time-frequency resource configuration information based on RRC information and store the pre-allocated time-frequency resource configuration information.

In some embodiments, the access unit is configured to send, in response to determining the TA compensation value by the compensation value determination unit, the initial access information to the NTN based on the TA compensation value, according to the stored time-frequency resource configuration information.

In some embodiments, the information acquisition unit is further configured to receive dynamic authorization information from the target cell based on DCI; the access unit is configured to send, in response to receiving the dynamic authorization information, the initial access information to the NIN based on the TA compensation value, according to the dynamic authorization information.

In some embodiments, the information acquisition unit is further configured to perform at least one of: receiving access confirmation information, wherein the terminal determines successful access according to the access confirmation information; or obtaining downlink data via a C-RNTI scrambled PDCCH or PDSCH, wherein the terminal determines successful access according to the downlink data.

According to one aspect of some embodiments of this disclosure, there is provided an NTN network-side device, including: a handover preparation interaction unit configured to send handover preparation information to a target cell for terminal handover; and an information transmission unit configured to send a RACH-less handover instruction, wherein the RACH-less handover instruction includes TA compensation assistance information.

In some embodiments, the RACH-less handover instruction further includes pre-allocated time-frequency resource configuration information for the terminal.

In some embodiments, the information transmission unit is further configured to send the pre-allocated time-frequency resource configuration information to the terminal using RRC information.

In some embodiments, the handover preparation interaction unit is further configured to receive dynamic authorization information from the target cell; the information transmission unit is further configured to send the dynamic authorization information to the terminal using DCI.

According to one aspect of some embodiments of this disclosure, there is provided an NTN network-side device, including: a handover preparation unit configured to obtain handover preparation information from a source cell for a terminal handover; an access information receiving unit configured to obtain initial access information from the terminal; and an access confirmation unit configured to send downlink data via a C-RNTI scrambled PDCCH or PDSCH.

In some embodiments, the access confirmation unit is further configured to send access confirmation information to the terminal.

In some embodiments, the handover preparation unit is further configured to generate, in response to receiving the handover preparation information, dynamic authorization information for the terminal and send the dynamic authorization information to the source cell.

According to one aspect of some embodiments of this disclosure, there is provided a network device, including: a memory; and a processor coupled to the memory, the processor configured to perform any one of the methods described above based on instructions stored in the memory.

According to one aspect of some embodiments of this disclosure, there is provided a computer-readable storage medium having stored thereon computer program instructions that, when executed by a processor, implement any one of the methods as described above.

According to one aspect of some embodiments of this disclosure, there is provided an NTN network-side system, including: a first network-side device configured to perform any one of the handover methods of the terminal excuted by a source cell side for terminal handover as mentioned above; a second network-side device configured to perform any one of the handover methods of the terminal for a target cell side for terminal handover as mentioned above.

According to one aspect of some embodiments of this disclosure, there is provided an NTN system, including: a terminal configured to perform any one of the methods performed by a terminal as mentioned above; and network-side devices, wherein at least one network-side device is configured to perform any one of the handover methods of the terminal executed by a source cell side for terminal handover as mentioned above; and at least one network-side device is configured to perform any one of the handover methods of the terminal executed by a target cell side for terminal handover as mentioned above.

According to an aspect of some embodiments of this disclosure, there is provided a computer program for causing a processor to execute any of the methods as described above.

According to an aspect of some embodiments of this disclosure, there is provided a computer program product including computer programs or instructions that, when executed by a processor, implement any of the methods as described above.

### BRIEF DESCRIPTION OF THE DRAWINGS

The accompanying drawings described here are intended to provide a further understanding of the present disclosure and constitute a part of the present disclosure. The illustrative embodiments of the present disclosure as well as the descriptions thereof, which are intended for explaining the present disclosure, do not constitute improper definitions on the present disclosure. In the accompanying drawings:

FIG. 1A is a flowchart of a handover method of a terminal according to some embodiments of the present disclosure.

FIG. 1B is a schematic diagram illustrating an application of a timing advance compensation value in the handover method of the terminal according to some embodiments of the present disclosure.

FIG. 2 is a flowchart of the handover method of the terminal according to other embodiments of the present disclosure.

FIG. 3 is a flowchart of the handover method of the terminal according to still other embodiments of the present disclosure.

FIG. 4 is a signaling flowchart of the handover method of the terminal according to some embodiments of the present disclosure.

FIG. 5 is a signaling flowchart of the handover method of the terminal according to other embodiments of the present disclosure.

FIG. 6 is a schematic diagram of a terminal according to some embodiments of the present disclosure.

FIG. 7 is a schematic diagram of an NTN network-side device according to some embodiments of the present disclosure.

FIG. 8 is a schematic diagram of the NIN network-side device according to other embodiments of the present disclosure.

FIG. 9 is a schematic diagram of a network device according to some embodiments of the present disclosure.

FIG. 10 is a schematic diagram of a network device according to other embodiments of the present disclosure.

FIG. 11 is a schematic diagram of an NIN network-side system according to some embodiments of the present disclosure.

FIG. 12 is a schematic diagram of an NIN system according to some embodiments of the present disclosure.

### DETAILED DESCRIPTION

Below, the technical solution of the present disclosure will be further described in detail with reference to the accompanying drawings and embodiments.

RACH-less, as a method that enables skipping a random-access procedure and directly switching to a target cell, can significantly reduce access delay. Existing standards in the prior art only support a RACH-less scheme for terrestrial cellular networks, and merely support a TA compensation value of 0 or a value identical to that of a source cell base station. However, the TA compensation procedure for non-terrestrial networks is relatively complex, requiring comprehensive consideration of factors such as feeder links, ephemeris information, and terminal location information. Moreover, due to the high communication delay, the communication procedure should be simplified as much as possible to reduce frequent interactions between the terminal and the network.

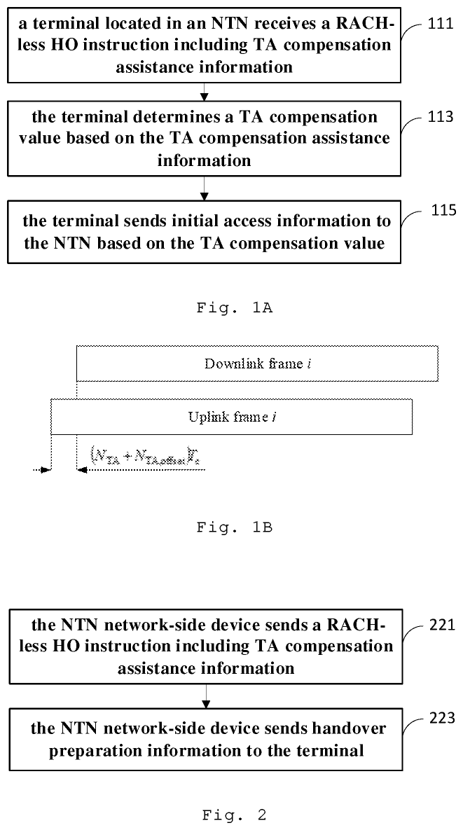

FIG. 1 shows a flowchart of a handover method of a terminal according to some embodiments of the present disclosure. The handover method of the terminal in FIG. 1A is performed by a terminal, which is a terminal provided with wireless access service by an NIN or a terminal supporting the capability of acquiring network service via an NTN.

In step 111, a terminal served by an NIN receives a RACH-less handover (RACH-less HO) instruction, the RACH-less HO instruction includes TA compensation assistance information. In some embodiments, the TA compensation assistance information is information required by the terminal to calculate a TA compensation value. The TA compensation value in the disclosure is also referred to as TA value. In some embodiments, the TA compensation assistance information includes ephemeris information and feeder link TA compensation information, to facilitate the terminal to obtain parameters for implementing NTN TA compensation and improves access efficiency. In some embodiments, the ephemeris information contained in the assistance information is ephemeris information of a target cell.

In some embodiments, the RACH-less handover instruction may be issued by a network-side device of a source cell (hereinafter referred to as the source cell, such as a satellite providing services for the source cell). In some embodiments, after determining that the terminal needs to perform RACH-less handover, the source cell prepares for handover with a network-side device of a target cell (hereinafter referred to as the target cell, such as a satellite providing services for the target cell).

In step 113, the terminal determines a TA compensation value based on the TA compensation assistance information. In some embodiments, the terminal determines corresponding compensation parameters based on the ephemeris information and the feeder link TA compensation information respectively, and then determines a TA compensation value in combination with parameters used by terminals to calculate TA compensation values in relevant technologies, thereby improving compatibility while adapting to NTN scenarios.

In some embodiments, the terminal determines a feeder circuit TA compensation value N_{TA,common} based on the feeder link TA compensation information in combination with the terminal's positioning, and determines a UE-specific TA compensation value N_{TA,UE-specific} based on the ephemeris information. Furthermore, the terminal determines a TA compensation value based on the feeder circuit TA compensation value and the UE-specific TA compensation value.

In some embodiments, the terminal can further determine a TA compensation measurement value N_{TA}. The TA compensation measurement value in the disclosure is also referred to as TA measurement value. In related technologies, the TA compensation measurement value N_{TA} is carried by a TAC (Timing Advance Command) sent from a base station-side to a UE via a MAC CE. During the communication with the source cell, the terminal obtains a N_{TA} between the terminal and the source cell, and then in the current step 113, determines whether a satellite corresponding to the target cell is the same as that corresponding to the source cell. If the target cell and the source cell are served by the same satellite, it is determined that the N_{TA} between the terminal and the target cell is the same as between the terminal and the source cell, and a current TA compensation value is calculated by the terminal using its N_{TA} between the terminal and the target cell. In some embodiments, if the target cell and the source cell are served by different satellites, it is not appropriate to use the N_{TA} between the terminal and the source cell. Instead, the N_{TA} between the terminal and the target cell can be set to a preset value, which in some embodiments is 0. In this method, it can be considered whether the cells correspond to the same satellite, and then a corresponding N_{TA} is determined, thereby improving the accuracy of the determined N_{TA}.

In some embodiments, the value included in the TA compensation assistance information in the RACH-less HO command includes N_{TA}, that is, the TA compensation assistance information refers to the timing adjustment, indicating the N_{TA} value which the UE shall use for handover. N_{TA} is obtained by reading the TA compensation assistance information. In some embodiments, the TA compensation assistance information of the present disclosure refers to N_{TA}, that is, the RACH-less HO command includes N_{TA}.

In some embodiments, the terminal determines a TA compensation value T_{TA} based on a feeder circuit TA compensation value N_{TA,common} and a UE-specific TA compensation value N_{TA,UE-specific}, in combination with a TA compensation measurement value N_{TA}, a TA offset N_{TA},offset, and a unit time duration T_{c}. In some embodiments, the TA compensation value T_{TA} can be determined according to the following formula. The feeder circuit TA compensation value in the disclosure is also referred to as feeder circuit TA value. The UE-specific TA compensation value in the disclosure is also referred to as UE-specific TA value.

$${T}_{T A} = ( {N}_{T A} + {N}_{TA , UE - specific} + {N}_{T A , c o m m o n} + {N}_{TA , offest} ) \times {T}_{c} \qquad ( 1 )$$

In the above formula, N_{TA},offset is a fixed offset depending on frequency bands and subcarriers, and T_{c} denotes the system's unit time duration.

In step 115, the terminal sends initial access information to the NTN based on the TA compensation value. The terminal initiates handover in the NTN based on the T_{TA}. The TA compensation value includes N_{TA}, therefore, the terminal initiates handover in the NTN according to N_{TA}.

In some embodiments, the Timing Advance TA is used to adjust uplink frame timing relative to the downlink frame timing, as shown in FIG. 1B, wherein FIG. 1B takes T_{TA}=(N_{TA}+N_{TA, offset})×T_{c} as an example.

Based on the method described in the above embodiment, a network-side device of the NTN source cell, when sending a RACH-less handover instruction to a terminal, can provide assistance information for the terminal to calculate a TA compensation value suitable for NTN. Based on the current technology, the terminal can promptly and autonomously calculate a TA compensation value by incorporating the assistance information, thereby simplifying the communication process of NIN terminal handover, overcoming the delay effects caused by the satellite service link and the feed link, reducing the failure probability of handover and improving the handover efficiency.

In some embodiments, in above step 115, the wireless resources invoked by the terminal for sending initial access information to the NTN based on the TA compensation value may be pre-configured. In some embodiments, in above step 111, the source cell can send time-frequency resource configuration information to the terminal along with the RACH-less handover instruction. The terminal can parse and store the time-frequency resource configuration information for use in step 115. In some embodiments, the source cell can also send pre-allocated time-frequency resource configuration information to the terminal using RRC information in advance, and the terminal can parse and store the time-frequency resource configuration information for use in step 115. In n some embodiments, the pre-configured time-frequency resource configuration information may have a validity period, which is determined by the source cell based on ephemeris information, requirements. The terminal needs to execute step 115 within this validity period.

In this method, resources can be pre-allocated before the occurrence of handover, thereby reducing the probability of conflicts among multiple users and addressing the issue of conflicts readily caused by frequent terminal handovers in NTN cells.

In some embodiments, in above step 115, the wireless resources invoked by the terminal for sending initial access information to the NTN based on the TA compensation value can be configured in real time. In some embodiments, the terminal receives dynamic authorization information from the target cell based on DCI. In some embodiments, DCI can be sent from the source cell to the terminal. After obtaining dynamic authorization information for the terminal from the target cell, the source cell sends the dynamic authorization information to the terminal using DCI. In response to receiving the dynamic authorization information, the terminal immediately sends initial access information to the NTN based on the TA compensation value calculated in step 113, according to the dynamic authorization information.

In this method, the terminal can be triggered by the DCI to immediately initiate the RACH-less procedure, making it more environmental suitable for scenarios with highly dynamic conditions.

In some embodiments, the terminal handover method further comprises step 117, in which the terminal receives access confirmation information and determines successful access based on the access confirmation information. In some embodiments, the access confirmation information may be information sent by the target cell via a link layer control element MAC CE after confirming the terminal's access. The terminal determines successful access based on this information. In some embodiments, the operation of sending access confirmation information via a MAC CE can be skipped. Instead, the target cell sends downlink data via a C-RNTI scrambled PDCCH or PDSCH. When the terminal receives the C-RNTI scrambled PDCCH or PDSCH downlink data, it determines that the access is successful.

In this method, after a successful RACH-less handover, if the network has downlink data for transmission to the terminal, the transmission of a MAC CE message indicating successful access can be skipped, and C-RNTI scrambled PDCCH/PDSCH data can be sent directly, thereby reducing signaling interaction and improving real-time performance of data transmission.

FIG. 2 shows a flowchart of the handover method of the terminal according to other embodiments of the present disclosure. The method of the embodiment shown in FIG. 2 is performed by an NTN network-side device, such as a satellite. In some embodiments, the NTN network-side device can serve as a network-side device on a source cell side for terminal handover, or as a network-side device on a target cell side for terminal handover. In some embodiments, the method of the embodiment shown in FIG. 2 can be performed if the NTN network-side device serves as a network-side device on the source cell side.

In step 221, the NIN network-side device sends handover preparation information to a target cell for terminal handover. In some embodiments, an NTN network-side device of a serving cell of a terminal can determine the need to hand over the terminal to another cell based on information such as terminal signal strength, terminal signal quality, location, etc., and then acting as a source cell, determine a target cell for the terminal and interact with a network-side device of the target cell. In some embodiments, the information exchanged with the network-side device of the target cell may include relevant information of the terminal.

In step 223, the NTN network-side device sends a RACH-less handover instruction to the terminal, which includes TA compensation assistance information. In some embodiments, the TA compensation assistance information includes ephemeris information and feeder link TA compensation information, to facilitate the terminal to obtain parameters for implementing NIN TA compensation, thereby improving access efficiency.

In some embodiments, the RACH-less handover instruction further includes pre-allocated time-frequency resource configuration information the terminal. In this method, resources can be pre-allocated in advance prior to the occurrence of handover, avoiding the probability of conflicts among multiple users and addressing the issue of conflicts readily caused by frequent terminal handovers in NTN cells.

In the method described in the above embodiment, when the network-side device of the NTN source cell sends RACH-less handover instruction to the terminal, it can provide assistance information that enables the terminal to calculate a TA compensation value suitable for NTN, which allows the terminal to promptly and autonomously compute the TA compensation value based on the assistance information and performs a RACH-less handover, thereby simplifying the communication process of NIN terminal handover, overcoming the delay effects caused by the satellite service link and the feed link, reducing the failure probability of handover and improving the handover efficiency.

In some embodiments, the network-side device of the source cell can also send pre-allocated time-frequency resource configuration information to the terminal by using RRC information. The terminal parses and stores the time-frequency resource configuration information for use when sending initial access information to the target cell, thereby achieving resource pre-allocation, avoiding the probability of conflicts among multiple users, and solving the problem that frequent terminal handovers in NTN cells are prone to causing conflicts.

In some embodiments, the network-side device of the source cell can receive dynamic authorization information provided by the target cell and send the dynamic authorization information to the terminal by using DCI. In response to receiving the dynamic authorization information, the terminal immediately sends initial access information to the NTN based on the calculated TA compensation value, according to the dynamic authorization information.

In this method, the terminal can be triggered by the DCI to immediately initiate the RACH-less procedure, making it more suitable for scenarios with highly dynamic environmental conditions.

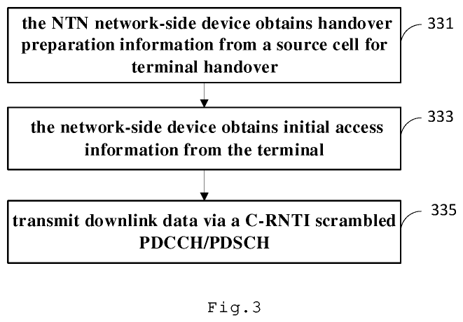

FIG. 3 shows a flowchart of the handover method of the terminal according to still other embodiments of the present disclosure. The method of the embodiment shown in FIG. 3 is performed by an NIN network-side device, such as a satellite. In some embodiments, the NTN network-side device can serve as a network-side device on a source cell side for terminal handover, or as a network-side device on a target cell side for terminal handover. In some embodiments, the method of the embodiment shown in FIG. 2 can be performed if the NTN network-side device serves as a network-side device on a target cell side.

In step 331, the NTN network-side device obtains handover preparation information from a source cell for terminal handover. In some embodiments, after determining that the terminal needs to perform a handover and selecting a target cell, the network-side device of the source cell sends handover preparation information to a network-side device of the target cell. The network-side device of the target cell receives the handover preparation information. In some embodiments, the network-side device of the target cell may determine whether to allow the terminal to perform handover, and may provide feedback information. In some embodiments, if the terminal is allowed to hand over to the target cell, feedback is provided to the network-side device of the source cell, enabling the network-side device of the source cell to execute step 223 as described above.

In step 333, the network-side device obtains initial access information from the terminal. In some embodiments, the terminal may perform the method of the embodiment corresponding to FIG. 1 to send the initial access information.

In some embodiments, the wireless resources on which the initial access information is based may be pre-configured for the terminal according to any of the methods described in the above embodiments. In some embodiments, after determining in step 331 that the terminal is allowed to hand over to the target cell, the network-side device of the target cell may generate dynamic authorization information for the terminal and send it to the source cell, the source cell then provides this information to the terminal, and the terminal transmits the initial access information based on the dynamic authorization information.

In step 335, the network-side device of the NTN target cell may, after step 333, send access confirmation information to the terminal via a MAC CE, enabling the terminal to promptly learn that the handover has succeeded.

In some embodiments, when there is a need for downlink data transmission, the network-side device of the NIN target cell may skip the step of sending access confirmation information to the terminal and directly transmit downlink data to the terminal via a C-RNTI scrambled PDCCH/PDSCH.

In this method, after a successful RACH-less handover, if the network has downlink data for transmission to the terminal, the transmission of a MAC CE message indicating successful access can be skipped, a C-RNTI scrambled PDCCH/PDMSH can be sent directly, thereby reducing signaling interaction and improving real-time performance of data transmission.

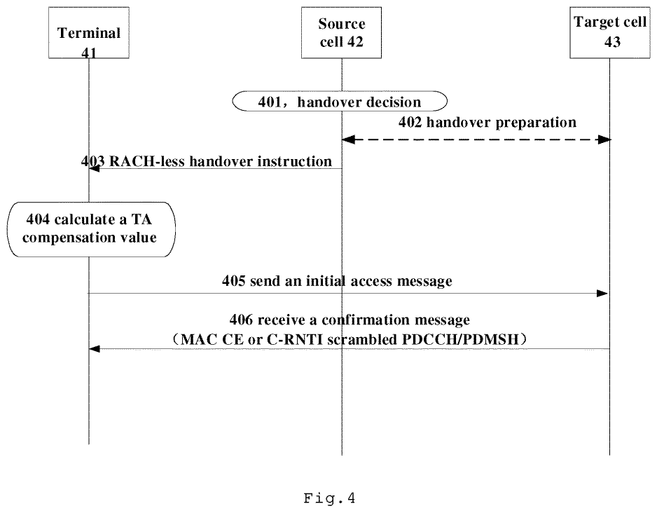

FIG. 4 shows a signaling flowchart of the terminal handover method according to some embodiments of the present disclosure.

In steps 401-402, a source cell 42 of an NIN network performs a handover decision for a terminal 41. If it is determined that a cell handover for the terminal 41 is required, a target cell 43 is determined, and the source cell proceeds handover preparation with the target cell 43. If it is determined that the target cell 43 can accept the terminal 41, the method proceeds to step 403.

In step 403, the source cell 42 sends a RACH-less handover instruction instructing the terminal to perform a RACH-less handover. This instruction includes TA compensation assistance information, such as ephemeris data of the target satellite and feeder link TA compensation information. In some embodiments, the RACH-less handover instruction may also include pre-configured time-frequency resource configuration information for the terminal to perform a handover to the target cell.

In some embodiments, the source cell 42 may send time-frequency resource configuration information to the terminal at any time prior to step 405, including before sending the RACH-less handover instruction.

In some embodiments, the source cell needs to specify a validity period for the time-frequency resource configuration information based on ephemeris data and network requirements. The terminal sends an initial access message within the validity period.

In step 404, the terminal 41 calculates a final TA compensation value T_{TA} based on its location information, ephemeris information of the target cell, and a feeder link TA compensation value. In some embodiments, the calculation method may be as presented in Equation (1) above.

In some embodiments, if the satellite corresponding to the target cell is the same as that of the source cell, the N_{TA} value remains identical to that of the original cell. If the satellite corresponding to the target cell is different from that of the source cell, the N_{TA} value is a predetermined value, such as 0. The terminal 41 can calculate N_{TA,UE-specific} based on its own location and ephemeris information. N_{TA,common} can be obtained based on the feeder link TA compensation value.

In step 405, the terminal 41 sends an initial access message to the target cell 43 based on the TA compensation value. In some embodiments, a RRCReconfigurationComplete message can be reused to send the initial access message.

In step 406, the target cell 43 sends an access confirmation message to the terminal in response to receiving the RRCReconfigurationComplete message. In some embodiments, this confirmation message can be a MAC CE, indicating the successful RACH-less handover of the terminal. If the target cell 43 has downlink data that needs to be sent to the terminal 41, it can directly send a C-RNTI scrambled PDCCH/PDSCH, skipping the step of sending the MAC CE confirmation message.

By using the method described in the above embodiment, the source cell can transmit TA compensation assistance information to the terminal. By combining this information with its own location data, the terminal can autonomously compensate for the TA value, thereby overcoming the delay impact caused by satellite service links and feeder links. By providing time-frequency resource configuration information to the terminal through pre-configuration and specifying a validity period corresponding to the time-frequency resource configuration information, the probability of conflicts among multiple users can be reduced; after a successful RACH-less handover, if the network has downlink data for transmission to the terminal, the transmission of a MAC CE message indicating successful access can be skipped, and a C-RNTI scrambled PDCCH/PDSCH can be directly sent to reduce signaling interaction and improve real-time performance of data transmission.

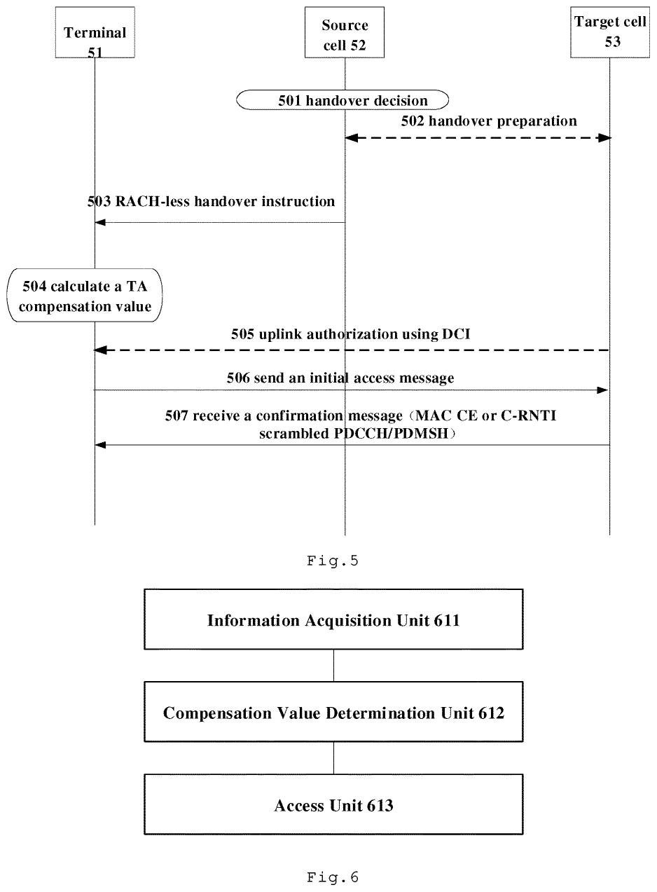

FIG. 5 shows a signaling flowchart of the terminal handover method according to other embodiments of the present disclosure.

Steps 501 and 502 are similar to above steps 401 and 402, respectively.

In step 503, a source cell 52 sends a RACH-less handover instruction to instruct a terminal to perform RACH-less handover, the instruction including TA compensation assistance information, such as ephemeris information of a target satellite and feeder link TA compensation information.

In step 504, the terminal 51 calculates a final TA compensation value T_{TA} based on its own location information, ephemeris information of a target cell, and a feeder link TA compensation value. In some embodiments, the calculation method may be as presented in Equation (1) above.

In some embodiments, if the satellite corresponding to the target cell is the same as that of the source cell, the N_{TA} remains identical to that of the original cell. If the satellite corresponding to the target cell is different from that of the source cell, the N_{TA} is a predetermined value, such as 0. The terminal 51 can calculate N_{TA,UE-specific} based on its location and the ephemeris information; N_{TA,common} can be obtained based on the feeder link TA compensation value.

In step 505, the target cell 53 performs uplink authorization to the terminal 51 and transmits dynamic authorization information to the terminal 51 via the source cell 52 using DCI.

In step 506, in response to receiving the dynamic authorization information, the terminal 51 immediately sends an initial access message to the network-side based on the TA compensation value obtained in step 503. In some embodiments, the RRCReconfigurationComplete message can be reused to send the initial access message.

In step 507, in response to receiving the RRCReconfigurationComplete message, the target cell 53 sends an access confirmation message to the terminal. In some embodiments, this confirmation message can be a MAC CE, indicating the successful RACH-less handover of the terminal; if the target cell 53 has downlink data that needs to be sent to the terminal 51, it can directly send a C-RNTI scrambled PDCCH/PDSCH, skipping the step of sending the MAC CE confirmation message.

By using the method described in the above embodiment, the source cell can transmit TA compensation assistance information to the terminal. By combining this information with its own location data, the terminal can autonomously compensate for the TA value, thereby overcoming the delay impact caused by satellite service links and feeder links. Providing dynamic authorization information to the terminal using DCI for transmission of initial access information, is well-suited for scenarios with highly dynamic environmental conditions; after a successful RACH-less handover, if the network has downlink data for transmission to the terminal, the transmission of a MAC CE message indicating successful access can be skipped, and a C-RNTI scrambled PDCCH/PDSCH can be directly sent to reduce signaling interaction and improve real-time performance of data transmission.

FIG. 6 shows a schematic diagram of a terminal according to some embodiments of the present disclosure. In some embodiments, the terminal is a terminal provided with wireless access service by an NTN or a terminal supporting the capability of acquiring network service via an NTN.

An information acquisition unit 611 can receive a RACH-less handover instruction from an NTN source cell, wherein the RACH-less handover instruction includes TA compensation assistance information. In some embodiments, the TA compensation assistance information is information required by the terminal to calculate a TA compensation value. In some embodiments, the TA compensation assistance information includes ephemeris information and feeder link TA compensation information, to facilitate the terminal to obtain parameters for implementing NIN TA compensation, and to improve access efficiency. In some embodiments, the ephemeris information contained in the assistance information is ephemeris information of a target cell.

A compensation value determination unit 612 can determine a TA compensation value based on the TA compensation assistance information. In some embodiments, the terminal determines corresponding compensation parameters based on the ephemeris information and the feeder link TA compensation information, and then determines a TA compensation value in combination with the parameters used by terminals to calculate TA compensation values in relevant technologies, thereby improving compatibility while adapting to NTN scenarios. In some embodiments, the compensation value determination unit 612 can determine the TA compensation value based on any of the methods in above step 113.

An access unit 613 can send initial access information to an NTN target cell based on the TA compensation value.

Such a terminal can utilize the RACH-less handover instruction to obtain assistance information for calculating a TA compensation value suitable for NTN. By promptly and autonomously computing the TA compensation value based on this assistance information, a RACH-less handover is performed, thereby simplifying the communication process of NTN terminal handover, overcoming the delay effects caused by the satellite service link and the feed link, reducing the failure probability of handover and improving the handover efficiency.

In some embodiments, the information acquisition unit 611 may further obtain and store pre-allocated time-frequency resource configuration information. In some embodiments, the time-frequency resource configuration information can be obtained along with the RACH-less handover instruction or based on RRC information. In some embodiments, after the compensation value determination unit 612 determines the TA compensation value, the access unit 613 can transmit initial access information to the NTN based on the stored time-frequency resource configuration information and the TA compensation value.

Such a terminal can pre-allocate resources before a handover occurs, thereby reducing the probability of conflicts among multiple users and addressing the issue of conflicts readily caused by frequent terminal handovers in NIN cells.

In some embodiments, the information acquisition unit 611 may receive dynamic authorization information of the target cell via downlink control information. The access unit 613 can, upon receiving the dynamic authorization information, transmit initial access information to the NTN based on the TA compensation value, according to the dynamic authorization information. Such a terminal can be triggered by DCI to immediately initiate a RACH-less procedure, making it more suitable for scenarios with highly dynamic environmental conditions.

In some embodiments, the information acquisition unit 611 can further receive access confirmation information, wherein the terminal determines successful access based on the access confirmation information. In some embodiments, the information acquisition unit 611 can further obtain downlink data via a C-RNTI scrambled PDCCH or PDSCH, the terminal does not need to receive separate successful access information, and determines successful access based on the received downlink data. Such a terminal can enhance real-time performance of data transmission while reducing signaling interaction.

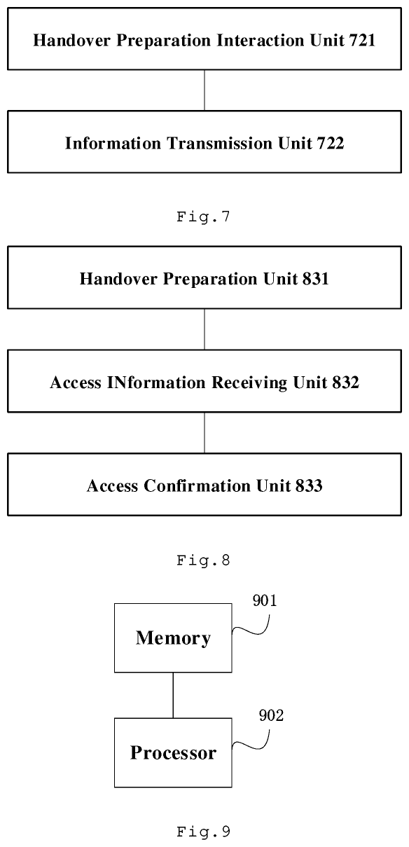

FIG. 7 shows a schematic diagram of an NIN network-side device according to some embodiments of the present disclosure.

A handover preparation interaction unit 721 can send handover preparation information to a target cell for terminal handover. In some embodiments, an NIN network-side device in a serving cell of a terminal can determine the need to hand over the terminal to another cell based on information such as terminal signal strength, terminal signal quality, location, etc, the handover preparation interaction unit 721 interacts with a network-side device of the target cell. In some embodiments, the interaction information may include relevant information of the terminal.

An information transmission unit 722 can send a RACH-less handover instruction to the terminal, the RACH-less handover instruction including TA compensation assistance information. In some embodiments, the TA compensation assistance information includes ephemeris information and feeder link TA compensation information, to facilitate the terminal to obtain parameters for implementing NTN TA compensation, thereby improving access efficiency.

In some embodiments, the RACH-less handover instruction further includes pre-allocated time-frequency resource configuration information for the terminal, which enables resource pre-allocation before the occurrence of handover, reduces the probability of conflicts among multiple users and addresses the issue of conflicts readily caused by frequent terminal handovers in NTN cells.

Such a network-side device, when sending a RACH-less handover instruction to the terminal, can provide assistance information that enables the terminal to calculate a TA compensation value suitable for NTN, which allows the terminal to promptly and autonomously compute the TA compensation value based on the assistance information and performs a RACH-less handover, thereby simplifying the communication process of NIN terminal handover, overcoming the delay effects caused by the satellite service link and the feed link, reducing the failure probability of handover and improving the handover efficiency.

In some embodiments, the information transmission unit 722 can further transmit pre-allocated time-frequency resource configuration information to the terminal by using RRC information. The terminal parses and stores this time-frequency resource configuration information for use when sending initial access information to the target cell, thereby achieving resource pre-allocation, avoiding the probability of conflicts among multiple users, and solving the problem that frequent terminal handovers in NTN cells are prone to causing conflicts.

In some embodiments, the handover preparation interaction unit 721 can further receive dynamic authorization information from the target cell. The information transmission unit 722 can further send dynamic authorization information to the terminal using downlink control information. In response to receiving the dynamic authorization information, the terminal immediately sends initial access information to the NIN based on the calculated TA compensation value, according to the dynamic authorization information.

Such a network-side device can trigger the terminal to immediately initiate a RACH-less procedure by using DCI, making it more suitable for scenarios with highly dynamic environmental conditions.

FIG. 8 shows a schematic diagram of an NIN network-side device according to other embodiments of the present disclosure.

A handover preparation unit 831 can obtain handover preparation information from a source cell for terminal handover. In some embodiments, after determining that a terminal needs to perform a handover and selecting a target cell, a network-side device of the source cell sends handover preparation information to a network-side device of a target cell. The handover preparation unit 831 receives the handover preparation information. In some embodiments, the handover preparation unit 831 may determine whether to allow the terminal to perform handover, and may provide feedback information. In some embodiments, if the terminal is allowed to hand over to the current cell, the handover preparation unit 831 provides feedback to the network-side device of the source cell, so that the network-side device of the source cell can perform above step 223.

In some embodiments, after determining that the terminal is allowed to hand over to the current cell, the handover preparation unit 831 may generate dynamic authorization information for the terminal. This dynamic authorization information is then transmitted to the source cell, which subsequently provides it to the terminal. The terminal sends initial access information based on this dynamic authorization information.

An access information receiving unit 832 can obtain the initial access information from the terminal. In some embodiments, the wireless resources on which the initial access information is based may be pre-configured for the terminal according to any of the methods described in the above embodiments.

An access confirmation unit 833 can send downlink data via a C-RNTI scrambled PDCCH or PDSCH. In some embodiments, the access confirmation unit can further send access confirmation information to the terminal. In some embodiments, when there is a need for downlink data transmission, the network-side device of the NTN target cell can skip the step of sending access confirmation information to the terminal.

Such an NTN network-side device can facilitate the RACH-less handover procedure for NTN terminals, simplifying the communication procedure for terminal handovers in NIN scenarios overcoming the delay effects caused by the satellite service link and the feed link, reducing the failure probability of handover and improving the handover efficiency. This approach supports sending downlink data directly to a terminal via a C-RNTI scrambled PDCCH/PDSCH, thus reducing signaling interaction while improving real-time performance of data transmission.

In some embodiments, the NTN network-side device may integrate both the units described in the embodiments shown in FIGS. 7 and 8, thereby possessing the capabilities of network-side devices of both a source cell and a target cell, which enables flexible handover of terminals between different cells.

FIG. 9 is a schematic structure diagram of a network device according to an embodiment of the present disclosure. The network device comprises a memory 801 and a processor 802, wherein the memory 901 may be a magnetic disk, flash memory or any other non-volatile storage medium. The memory is used to store the instructions of the handover method of a terminal according to a corresponding embodiment described above. The processor 902 is coupled to memory 901 and may be implemented as one or more integrated circuits, such as a microprocessor or microcontroller. The processor 902 is used to execute the instructions stored in the memory, thereby simplifying the communication procedure for terminal handovers in NIN scenarios, overcoming the delay impact caused by satellite service links and feeder links, reducing the probability of handover failure, and enhancing handover efficiency.

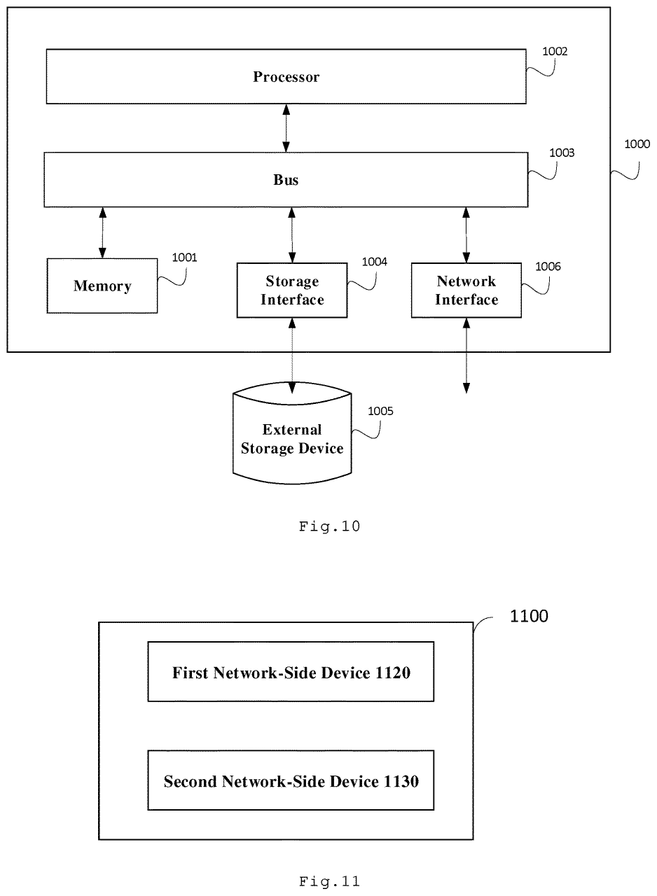

In some embodiments, as illustrated in FIG. 10, the network device 1000 includes a memory 1001 and a processor 1002. The processor 1002 is coupled to the memory 1001 via a bus 1003. The network device 1000 may be further connected to an external storage device 1005 through a storage interface 1004 to access external data, and may be further connected to a network or another computer system (not shown) through a network interface 1006, the details of which will not be described herein.

In this embodiment, data instructions are stored in memory and executed by a processor, which can simplify the communication procedure for terminal handovers in NTN scenarios, overcomes the delay impact caused by satellite service links and feeder links, reduce the probability of handover failure, and enhance handover efficiency.

In another embodiment, there is provided a computer readable storage medium having stored thereon computer program instructions that, when executed by a processor, implement the steps of the handover method of the terminal of corresponding embodiments. One skilled in the art should understand that, the embodiments of the present disclosure may be provided as a method, an apparatus, or a computer program product. Therefore, embodiments of the present disclosure can take the form of an entirely hardware embodiment, an entirely software embodiment or an embodiment containing both hardware and software elements. Moreover, the present disclosure may take the form of a computer program product embodied on one or more computer-usable non-transitory storage media (including but not limited to disk storage, CD-ROM, optical storage device, etc.) having computer-usable program code embodied therein.

FIG. 11 shows a schematic diagram of an NIN network-side device 1100 according to some embodiments of the present disclosure.

A first network-side device 1120 can perform any one of the handover methods of the terminal executed by a source cell side for terminal handover as mentioned above.

A second network-side device 1130 can perform any one of the handover methods of the terminal for a target cell side for terminal handover as mentioned above.

In this NTN network-side system, a network-side device, when sending a RACH-less handover instruction to a terminal, can provide assistance information for the terminal to calculate a TA compensation value suitable for NTN. The terminal can promptly and autonomously calculate the TA compensation value by incorporating the assistance information based on the current technology, and facilitate RACH-less handover, thereby simplifying the communication procedure for NTN terminal handover, overcoming the delay impact introduced by satellite service links and feeder links, reducing the probability of handover failure, and enhances handover efficiency.

In some embodiments, each network-side device in the NTN network-side system can perform any handover method of the terminal executed by the source cell side and any handover method of the terminal executed by the target cell side as described above for terminal handover, to enable flexible handover of terminals between cells.

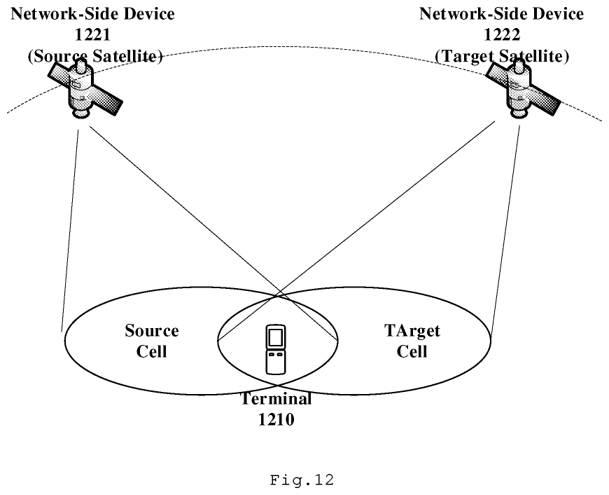

FIG. 12 shows a schematic diagram of an NIN system according to some embodiments of the present disclosure.

A terminal 1210 can perform any one of the methods performed by a terminal as mentioned above.

Network-side devices 1221 and 1222, wherein at least one network-side device (e.g., a source satellite 1221) can perform any handover method of the terminal executed by a source cell side for terminal handover as mentioned above, and at least one network-side device (e.g., a target satellite 1222) can perform any handover method of the terminal executed by a target cell side for terminal handover as mentioned above. In some embodiments, each network-side device can support at least one cell, and a network-side device can simultaneously function as both a source cell device and a target cell device to implement the handover methods of the terminal.

In this NTN system, a network-side device, when sending a RACH-less handover instruction to a terminal, can provide assistance information for the terminal to calculate a TA compensation value suitable for NTN. The terminal can promptly and autonomously calculate the TA compensation value by incorporating the assistance information based on the current technology, and facilitate RACH-less thereby handover, simplifying the communication procedure for NTN terminal handover, overcoming the delay impact introduced by satellite service links and feeder links, reducing the probability of handover failure, and enhances handover efficiency.

The present disclosure is described with reference to flowcharts and/or block diagrams of methods, apparatuses (systems) and computer program products according to embodiments of the present disclosure. It should be understood that each process and/or block in the flowcharts and/or block diagrams, and combinations of the processes and/or blocks in the flowcharts and/or block diagrams may be implemented by computer program instructions. The computer program instructions may be provided to a processor of a general purpose computer, a special purpose computer, an embedded processor, or other programmable data processing apparatus to generate a machine such that the instructions executed by a processor of a computer or other programmable data processing apparatus to generate means implementing the functions specified in one or more flows of the flowcharts and/or one or more blocks of the block diagrams.

The computer program instructions may also be stored in a computer readable storage device capable of directing a computer or other programmable data processing apparatus to operate in a specific manner such that the instructions stored in the computer readable storage device produce an article of manufacture including instruction means implementing the functions specified in one or more flows of the flowcharts and/or one or more blocks of the block diagrams.

These computer program instructions can also be loaded onto a computer or other programmable device to perform a series of operation steps on the computer or other programmable device to generate a computer-implemented process such that the instructions executed on the computer or other programmable device provide steps implementing the functions specified in one or more flows of the flowcharts and/or one or more blocks of the block diagrams.

Heretofore, the present disclosure has been described in detail. In order to avoid obscuring the concepts of the present disclosure, some details known in the art are not described. Based on the above description, those skilled in the art can understand how to implement the technical solutions disclosed herein.

The method and apparatus of the present disclosure may be implemented in many ways. For example, the method and apparatus of the present disclosure may be implemented by software, hardware, firmware, or any combination of software, hardware, and firmware. The above sequence of steps of the method is merely for the purpose of illustration, and the steps of the method of the present disclosure are not limited to the above-described specific order unless otherwise specified. In addition, in some embodiments, the present disclosure may also be implemented as programs recorded in a recording medium, which include machine-readable instructions for implementing the method according to the present disclosure. Thus, the present disclosure also covers a recording medium storing programs for executing the method according to the present disclosure.

It should be noted that the terms “first”, “second” and the like in the description and claims of the present disclosure and the drawings are used to distinguish similar objects, and are not necessarily used to describe a specific order or sequence. It should be understood that the terms so used may be interchanged where appropriate so that the embodiments of the disclosure described herein can be implemented in an order other than those illustrated or described herein. Furthermore, the terms “including” and “having” and any of their variations are intended to cover non-exclusive inclusions, for example, a process, method, system, product, or device that includes a series of steps or units need not be limited to those explicitly listed, instead it can include other steps or units not explicitly listed or inherent to this process, method, product or device.

Finally, it should be noted that: the above embodiments are only intended to explain the technical solution of the present disclosure rather than limiting the same; although detailed explanations are made to the present disclosure with reference to preferred embodiments, those of ordinary skill in the art should understand that: it is still possible to make amendments to the embodiments of the present disclosure or equivalent replacements to some of the technical features, which shall all be encompassed in the scope of the technical solution for which protection is sought in the present disclosure without departing from the spirit of the technical solution of the present disclosure.

What is claimed is:

1. A handover method of a terminal, executed by the terminal, comprising:
receiving a RACH-less (Random Access Channel-less) handover instruction, wherein the RACH-less handover instruction comprises TA (Time Advance) compensation assistance information; and
initiating handover in the NTN according to the TA compensation assistance information.

2. The handover method of the terminal according to claim 1, wherein the initiating handover in the NTN according to the TA compensation assistance information comprising:
determining a TA value based on the TA compensation assistance information; and
initiating handover in the NTN based on the TA value.

3. The handover method of the terminal according to claim 1, wherein the TA compensation assistance information comprises at least one of ephemeris information or feeder link TA compensation information.

4. The handover method of the terminal according to claim 1, wherein the RACH-less handover instruction further comprises pre-allocated time-frequency resource configuration information.

5. The handover method of the terminal according to claim 1, wherein:
the handover method further comprises: obtaining pre-allocated time-frequency resource configuration information based on RRC (Radio Resource Control) information and storing the pre-allocated time-frequency resource configuration information;
or
the method satisfies at least one of:
the RACH-less handover instruction being a RACH-LessHO message;
the TA compensation assistance information being carried by a targetNTA field; or
the initiating handover is processed by sending information of a first uplink transmission.

6. The handover method of the terminal according to claim 2, further comprising: receiving dynamic authorization information from a target cell based on DCI (downlink control information);
wherein the terminal initiating handover in the NTN based on the TA value comprises:
initiating handover, in response to receiving the dynamic authorization information, with the NTN based on the TA value, according to the dynamic authorization information.

7. The handover method of the terminal according to claim 3,
wherein the determining the TA value based on the TA compensation assistance information comprises:
determining a feeder circuit TA value based on the feeder link TA compensation information;
determining a UE-specific TA value based on the ephemeris information; and
determining the TA value based on the feeder circuit TA value and the UE-specific TA value.

8. The handover method of the terminal according to claim 7, wherein the determining the TA value based on the TA compensation assistance information further comprises:
determining a TA measurement value.

9. The handover method of the terminal according to claim 8, wherein:
the determining the TA value based on the feeder circuit TA value and the UE-specific TA value comprises: determining the TA value based on the feeder circuit TA value, the UE-specific TA value, and in combination with the TA measurement value, a TA offset, and a unit time duration;
or
the determining the TA measurement value comprises at least one of:
determining the TA measurement value of a target cell to be identical to the TA measurement value of a source cell, in a case where the source cell and the target cell correspond to the same satellite; or
determining the TA measurement value as a preset value, in a case where the source cell and the target cell correspond to different satellites.

10. The handover method of the terminal according to claim 1, further comprising:
receiving access confirmation information; and
determining an access being successful according to the access confirmation information.

11. The handover method of the terminal according to claim 10, wherein the access confirmation information is carried by a MAC (Medium Access Control) CE (Control Element);
or
the access being successful refers to the RACH-less handover being successful.

12. The handover method the terminal according to claim 1, further comprising:
the terminal obtaining downlink data via a PDCCH for C-RNTI, wherein the terminal determines successful access according to the downlink data; or
the terminal obtaining downlink data via a PDSCH for C-RNTI, wherein the terminal determines successful access according to the downlink data.

13. A handover method of a terminal, executed by a network-side device of an NTN, comprising:
sending handover preparation information to a target cell for the terminal handover; and
sending a RACH-less handover instruction, wherein the RACH-less handover instruction comprises TA compensation assistance information.

14. The handover method of the terminal according to claim 13,
wherein the RACH-less handover instruction further comprises pre-allocated time-frequency resource configuration information for the terminal;
or
the handover method of the terminal further comprising at least one of:
sending the pre-allocated time-frequency resource configuration information to the terminal using RRC information;
or
receiving dynamic authorization information from the target cell; and sending the dynamic authorization information to the terminal using DCI.

15. A handover method of a terminal, executed by a network-side device of an NTN, comprising:
obtaining handover preparation information from a source cell for the terminal handover;
obtaining initial access information from the terminal; and
sending downlink data via a PDCCH or PDSCH for C-RNTI.

16. The handover method of the terminal according to claim 15, further comprising at least one of:
sending access confirmation information to the terminal; or
generating dynamic authorization information for the terminal after receiving the handover preparation information; and sending the dynamic authorization information to the source cell.

17. A network device, comprising:
a memory; and
a processor coupled to the memory, the processor configured to perform, based on instructions stored in the memory, the method according to claim 1.

18. A non-transitory computer-readable storage medium stored thereon computer program instructions which, when executed by a processor, implement the steps of the method according to claim 1.

19. An NTN network-side system, comprising:
a first network-side device configured to perform the method according to claim 13; and
a second network-side device configured to perform the method of:
obtaining handover preparation information from a source cell for the terminal handover;
obtaining initial access information from the terminal; and
sending downlink data via a PDCCH or PDSCH for C-RNTI.

20. An NTN system, comprising:
a terminal configured to perform the method according to claim 1; and
network-side devices,
wherein at least one of the network-side devices is configured to perform the method of: sending handover preparation information to a target cell for the terminal handover; and sending a RACH-less handover instruction, wherein the RACH-less handover instruction comprises TA compensation assistance information;
and at least one of the network-side devices is configured to perform the method of: obtaining handover preparation information from a source cell for the terminal handover; obtaining initial access information from the terminal; and sending downlink data via a PDCCH or PDSCH for C-RNTI.
